(19) United States
(12) Patent Application Publication
(10) Pub. No.: US 2012/0179549 A1
(43) Pub. Date: Jul. 12, 2012

(54) METHOD AND SYSTEM FOR DELIVERING LOCATION-BASED ADVERTISING MESSAGES

(75) Inventors: Safan Sigmund, Palo Alto, CA (US); Tami T. Tran, Palo Alto, CA (US)

(73) Assignee: TotalPaas, Inc., Palo Alto, CA (US)

(21) Appl. No.: 13/344,493

(22) Filed: Jan. 5, 2012

Related U.S. Application Data
(60) Provisional application No. 61/430,439, filed on Jan. 6, 2011.

(51) Int. Cl. G06Q 30/02

(52) U.S. Cl. 705/14.58

(57) ABSTRACT

Methods for providing distance-based delivery of advertising messages to users operating location-aware devices are described. A distance-based ad server receives ad content associated with a bounded distance from a geographic location, and also receives from each advertiser a payment, based on the distance from the physical geographic location, placement areas, and placement time interval for distributing the ad content to consumers located within the bounded area. The price charged for transmitting the ad is based on one of: a fixed pricing model that imposes the same price on all ads for a certain geographic reach and duration, a graduated pricing model that imposes a different price on ads depending on geographic reach or duration, and a bidding model that imposes a price based on an average price for a target area and bids received by a plurality of advertisers.

### CROSS-REFERENCE TO RELATED APPLICATIONS

The present application claims the benefit of the U.S. Provisional Application No. 61/430,439 filed on Jan. 6, 2011 and entitled “Distance-Based Advertising.”

### FIELD

Embodiments of the invention relate generally to electronic commerce systems, and more specifically, to location-based advertising delivery.

### BACKGROUND

Distance-based services are services available to users through various devices, such as personal navigation devices (PND). Such services use mobile networks that make use of a geographic location of a device accessing the network to provide location-specific information to the user and other relevant parties. Examples of distance-based services may include identifying businesses near a user, and helping drivers or pedestrians navigate to a desired destination.

Various mechanisms may be used to determine a location of a user. Examples of locating mechanisms include global positioning systems (GPS) and multilateration methods. Such locating capabilities may be included in a variety of location-aware devices, including but not limited to GPS devices, cell phones, smart phones, laptop computers, desktop computers, and so on. As the number of devices equipped with such locating capabilities continues to rise, the market for distance-based services will continue to rise correspondingly.

The use of location information has been exploited by advertisers to deliver targeted ads that are ostensibly more relevant to users because of their offer of goods and services that are in the immediate vicinity of the user. Traditional computer-based ad delivery models are usually based on impressions or clicks through a web browser. A major factor in the use of location-based ad serving is in establishing fair prices for delivering ads to users. Presently, the pricing model for ads is usually based on a bidding system that forces the advertisers to name their price. Ad distribution and visibility thus depends largely on the price that an advertiser is willing to pay. This results in a system in which a small business is disadvantaged in its ability get good visibility for their ads, even though they may be well-placed to attract customers.

The situation is similar on the publisher side, in which only websites that have millions of visitors can generate profits with advertising. Websites that serve only a certain geographical area, such as community portals or local marketplaces, are generally not able to monetize based on high traffic, since these sites are more exposed to returning users and users who spend longer periods of time on the site. Because of these factors, traditional ad models do not work particularly well for all publishers, and this further disadvantages users who are not exposed to potentially attractive offers from a variety of local and small vendors.

What is needed, therefore, is a location and distance based ad model that serves the needs of both the advertisers and the publishers. Such a system would allow a small business that is focused on the local community to target the audience in its neighborhood without paying high prices for advertising that does not target the right customers. Similarly, such a system would allow publishers to sell local ad services to businesses that would otherwise not be able or willing to pay for traditional advertising models.

### BRIEF DESCRIPTION OF THE DRAWINGS

Embodiments of the present invention are illustrated by way of example and not limitation in the figures of the accompanying drawings, in which like references indicate similar elements and in which:

FIG. 1A is a block diagram of a computer network system that implements embodiments of a distance-based advertising delivery system;

FIG. 1B shows an embodiment of a method of operating a distance-based advertising server, under an embodiment.

FIG. 2 shows a block diagram of an embodiment of a distance-based advertising use environment.

FIG. 3 shows an embodiment of a map of a geographic region with a bounded area determined by a circular distance (radius) from a geographic location (center point).

FIG. 4 shows an embodiment of method of interacting with a distance-based advertising server.

FIG. 5 shows an alternative embodiment of a method of operating a distance-based advertising server.

FIG. 6 is a diagram that illustrates the hierarchical schema for representing location using city areas and neighborhoods, under an embodiment.

FIG. 7 illustrates the determination of the center point of a city based on the average values of lat/long pairs of the city.

FIG. 8 illustrates the determination of a neighborhood of a city, under an embodiment.

FIG. 9 is a diagram that illustrates the hierarchical schema 900 for representing user information including location information, under an embodiment.

FIG. 10 illustrates an example of different search radii for passive local advertising, under an embodiment.

FIG. 11 is a diagram illustrating a workflow associated with determining business listings displayed to users in a passive local advertising embodiment.

FIG. 12 illustrates an example of a search radius for active local advertising, under an embodiment.

FIG. 13 is a diagram illustrating a workflow associated with determining business listings displayed to users in an active local advertising embodiment.

FIG. 14 illustrates an example of a different pricing tiers based on geographic distance in a graduated pricing model, under an embodiment.

### DETAILED DESCRIPTION

Embodiments are directed to a method and system for providing distance-based advertising services and delivery of location-based advertising messages to users operating location-aware devices. A distance-based advertising server receives, from an advertiser or advertising publisher, an item of advertising content associated with a bounded distance from a physical geographic location, and also receives from each advertising publisher a payment, based on the distance from the physical geographic location, placement areas, and placement time interval for distributing the advertising publisher's item of advertising content to consumers and devices located within the bounded area. For purposes of the following description, the terms ‘distance-based’ and ‘location-based’ delivery both refer to the delivery of a message based on a specific distance from a geographic location as defined by a geographic region defined by a bounded area.

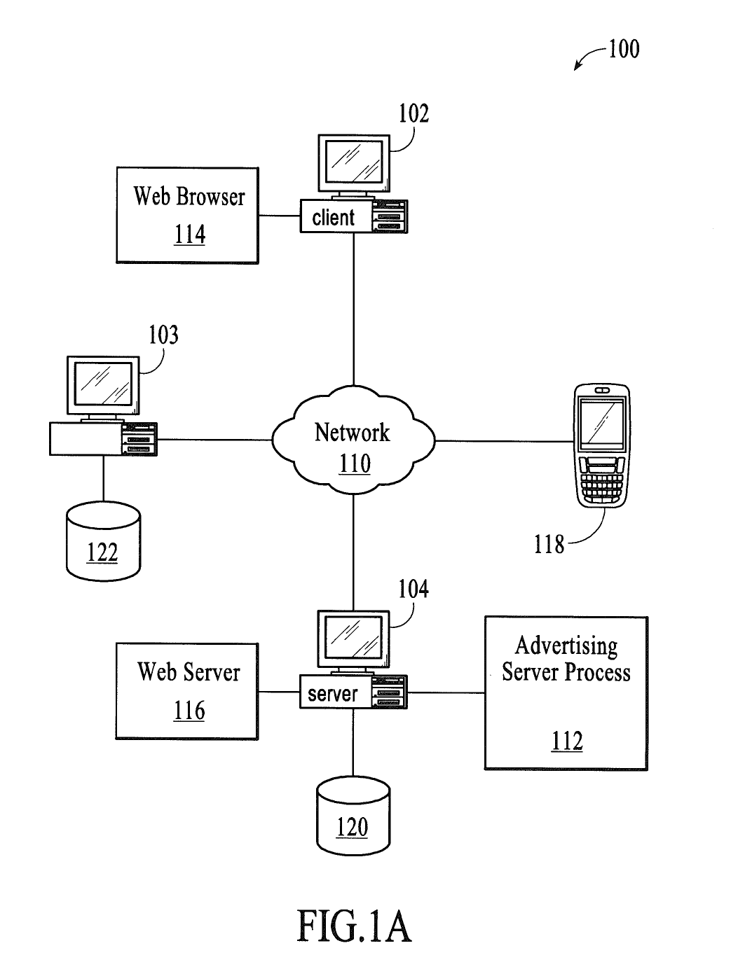

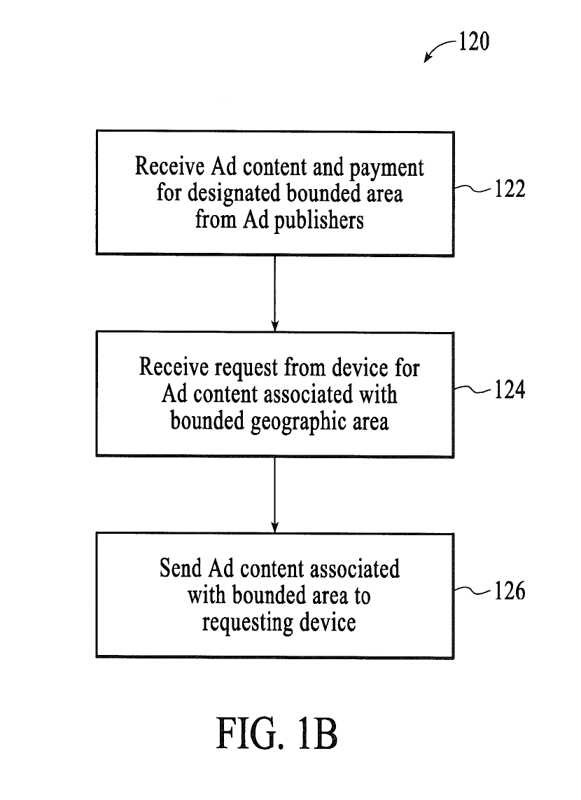

Aspects of the one or more embodiments described herein may be implemented on one or more computers executing software instructions. The computers may be networked in a client-server arrangement or similar distributed computer network. FIG. 1A illustrates a computer network system 100 that implements one or more embodiments. In system 100, a network server computer 104 is coupled, directly or indirectly, to one or more network client computers 102 through a network 110. The network interface between server computer 104 and client computer 102 may include one or more routers that serve to buffer and route the data transmitted between the server and client computers. Network 110 may be the Internet, a Wide Area Network (WAN), a Local Area Network (LAN), or any combination thereof.

In one embodiment, the server computer 104 is a World-Wide Web (WWW) server that stores data in the form of web pages and transmits these pages as Hypertext Markup Language (HTML) files over the Internet 110 to the client computer 102. For this embodiment, the client computer 102 typically runs a web browser program 114 to access the web pages served by server computer 104 and any available content provider or supplemental server 103.

In one embodiment, server 104 in network system 100 is a server that executes a server-side, distance-based ad serving process 112. Client versions of this process may also be executed on the client computers, if necessary, depending on system implementation requirements. Server process 112 may represent one or more executable programs modules that are stored within network server 104 and executed locally within the server. Alternatively, however, it may be stored on a remote storage or processing device coupled to server 104 or network 110 and accessed by server 104 to be locally executed. In a further alternative embodiment, the advertising process 112 may be implemented in a plurality of different program modules, each of which may be executed by two or more distributed server computers coupled to each other, or to network 110 separately.

For an embodiment in which network 110 is the Internet, network server 104 executes a web server process 116 to provide HTML documents, typically in the form of web pages, to client computers coupled to the network. To access the HTML files provided by server 104, client computer 102 executes a web browser process 114 that accesses web pages available on server 104 and other Internet server sites, such as content provider 103 (which may also be a network computer, such as a publisher computer executing certain web publishing processes). The client computer 102 may access the Internet 110 through an Internet Service Provider (ISP). Data for any of the ad messages and associated goods and services, and vendors may be provided by a data store 120 that is closely or loosely coupled to any of the server 104 and/or client 102. A separate content provider 103 may provide some of the data that is included in the ad serving process.

The client computer 102 may be a workstation computer or it may be a computing device such as a notebook computer, personal digital assistant, or the like. The client computer may also be embodied within a mobile communication device 118, game console, media playback unit, or similar computing device that provides access to the Internet network 110 and a sufficient degree of user input and processing capability to execute or access any required client-side application. The client computers 102 and 118 may be coupled to the server computer 104 over a wired connection, a wireless connection or any combination thereof. The client computers and devices 102 and 118 are assumed to have sufficient location-aware capability to provide a present location of the device to the network 110. This information is used by the server 104 and any other relevant computer 103 to serve ad messages that are displayed on the client display. The client computer is operated by a user, who may be a person that is registered with an advertising-related service provider and who shows interest in certain ad messages by logging into a web-based portal supported by an ad server, ad publisher, advertiser, or similar ad related platform.

FIG. 1B is a flowchart illustrating a method 120 of providing distance-based advertising services, under an embodiment. In general terms, an ad publisher uses the ad server to deliver ads to users based on the location of the users, and pays for this service. In an embodiment, the ad server process 112 executes one or more programs to implement this transaction. As shown in FIG. 1B, the method comprises receiving advertising content and payment from each advertising publisher, block 122. The pricing comprises an offer to pay a specified amount of money in exchange for having the advertising content of the advertising publisher sent to a device for presentation to a user. The advertising content is associated with a specific bounded geographic area defined in a geographic region. Therefore, the advertising content is sent to devices located within, or within some distance adjacent to, the bounded area. Next, method 120 comprises, at block 124, receiving a request from a device for advertising content associated with the bounded area. In block 126, the advertising content associated with the bounded area is then sent to the device for presentation to a user of the device.

Depending upon various device-specific parameters of the device and the nature of the advertising content sent to the device, one or more items of advertising content may be presented on the device at any one time. As a specific example, a GPS-enabled smart phone may allow a map to be displayed at various levels of zoom. In one example, for a specific level of zoom in a specific geographic region, the smart phone may be able to display three items of advertising content on a map. In this case, the device may be sent items of advertising content for three advertising publishers for the geographic area displayed on the map.

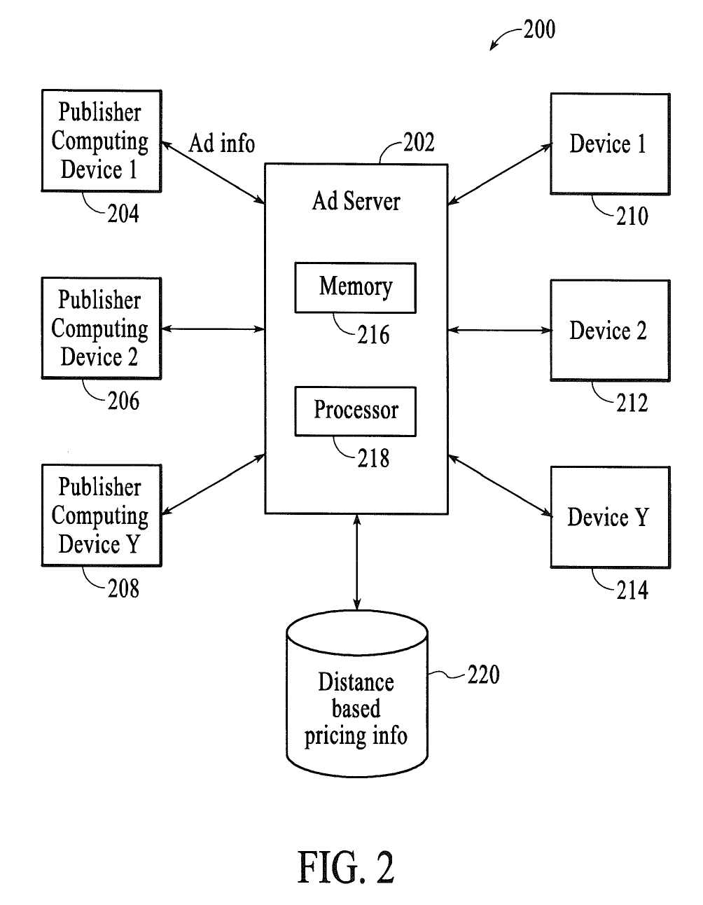

FIG. 2 shows an example embodiment of a distance-based advertising use environment 200, under an embodiment. The use environment 200 comprises an advertising server 202 in communication with a plurality of advertising publisher computing devices 204, 206, 208, and also with a plurality of client devices 210, 212, 214 that request and receive advertising content from the advertising server 202. In the depicted embodiment, the number of advertising publisher computing devices in communication with the advertising server 202 is illustrated as a generic number X, and the number of requesting/receiving client devices is illustrated as a generic number Y, indicating that any suitable number of advertising publisher computing devices and requesting/receiving devices may be in communication with the advertising server 202 at any time. In a computer-based network environment, the advertising server 202 may be embodied as a server computer 104, as shown in FIG. 1A, the publisher server may be embodied as a supplemental server 103, and the devices 204-214 may be embodied as client devices 102 or 118.

In a typical network implementation, the advertising server 202 includes certain components, such as memory 216 and processor 218, wherein the memory 216 comprises instructions stored thereon that are executable by the processor 218 to perform the various methods of operating an advertising server disclosed herein. The advertising server 202 further includes or is coupled to a database 220 that stores various items of information related to the provision of distance-based advertising services. For example, the database 220 may store user account information related to the advertising publishers and/or consumer (user) devices that utilize the system. The database 220 also may store advertising content provided by each advertising publisher, and pricing information related to the advertising content. The pricing information may include such information as the geographic locations and time intervals selected by each advertising publisher for the distribution of advertising content, placement information related to the placement of advertising content provided by each advertising publisher and to the specific distribution services requested by the advertising publisher, payment information related to the method of payment used by each advertising publisher (pre-paid credits, debit/credit card info, etc.), or any other suitable information.

Each publisher computing device 204, 206, 208 also comprises memory having stored instructions executable by a processor for performing the various client-side methods disclosed herein. Likewise, each of the client devices 210, 212, 214 include appropriate processor and memory resources to request, receive and display ad messages provided by ad server 202. The client devices 210, 212, 214 also include geo-location circuitry or processes that make the devices location-aware. In this manner, the actual physical location of the device and the respective user can be determined when a request for ad messages is made, and this location information is used by the ad server to serve the appropriate ad messages based on the location of the device user.

Upon receipt of physical geographic information and distance information, an advertising publisher computing device 204 may receive an input of a selection of one geographic region the publisher wishes to have its advertising content distributed, and then send the selection to the advertising server along with the item or items of advertising content the publisher wishes to distribute. The advertising publisher computing device 204 also may send other advertising information, such as advertising placement information and desired advertising times, to the advertising server 202. This information is collectively referred to as “ad info” in FIG. 2. Upon receipt of this information from a publisher computer, the advertising server 202 may provide pricing information back to the advertising publisher 204. As described below, the pricing information may be updated if the advertising publisher increases or decreases the geographic area.

Any suitable placement information may be sent by the advertising publisher computing devices 204, 206, 208 to the advertising server 202. For example, such placement information may comprise an area or section the publisher wishes to distribute advertising content. Examples of advertising content items include, but are not limited to, sound-based ads, image-based ads, text-based ads, interactive ads, static ads, video clips, and the like. More advanced advertising content information and message types also may be supported.

Examples of more advanced advertising content information that may be sent by an advertising publisher include, but are not limited to, information regarding a size of the advertising content on the display, and/or a presence or absence of sound to accompany an image-based or text-based advertising content item. A more specific example comprises a choice between a large icon and a small icon displayed on a map. Another more specific example comprises a choice of displaying a map icon with or without sound.

In other embodiments, the placement information may comprise a type of device on which an advertising publisher wishes to display advertising content, and/or a zoom level on a device at which the advertising publisher wishes for an item of advertising content to be triggered. For example, an advertising publisher may wish to display one item of advertising content on smaller devices, such as cell phones, and another item of advertising content on larger devices, such as laptop computers. Therefore, in some embodiments, the advertising publisher may have the ability to specify a type of device, brand/model of device, etc. on which specific advertising content is to be presented.

With continuing reference to FIG. 2, the advertising server 202 is also configured to provide advertising content to devices 210, 212, 214 that request content for specified locations. When requesting advertising content, a device (such as device 210) sends information regarding its geographic location to the advertising server 202. Such information may comprise the devices latitude/longitude data as provided by local GPS or similar circuitry, or it may be other location information, such as address information provided by user input or location determining processes provided by the device or a service provider, or both. The device 210 also may send other information to the advertising server 202. For example, the device 210 may send information regarding its type, manufacturer and/or model identity. Such information may allow the advertising server 202 to select items of advertising content intended for that type of device. The device 210 also may send information regarding display parameters, such as screen size and a current zoom level at which the display on the device is currently being viewed. Such information may allow the advertising server to select items of advertising content configured to trigger at the specified level of zoom, and/or to determine how many items of advertising content can be viewed at one time on the device display and therefore to select how many advertising content items to send to the device.

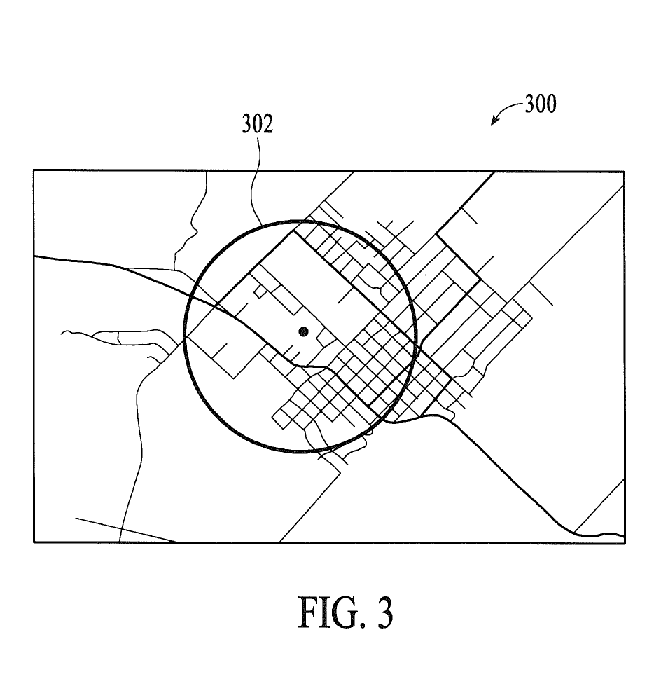

After determining how many items of advertising content to send to the device, the advertising server 202 may be configured to identify the items of advertising content associated with the geographic region and send the identified items of advertising content to the device. In this manner, ad messages are delivered to users within a defined region. The defined region may be specified as a distance from a particular geographic point of reference, such as a store address or city area. FIG. 3 shows an embodiment of a map of a geographic region with a bounded area 302 determined by a circular distance (radius) from a geographic location (center point). As shown in map display, the defined area 302 is represents the area in which users will be delivered ads for a particular publisher.

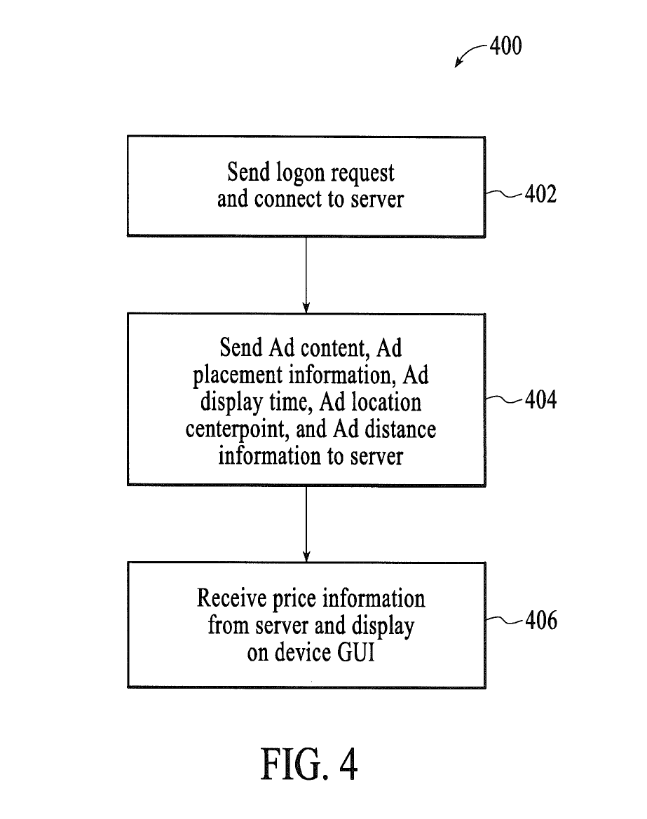

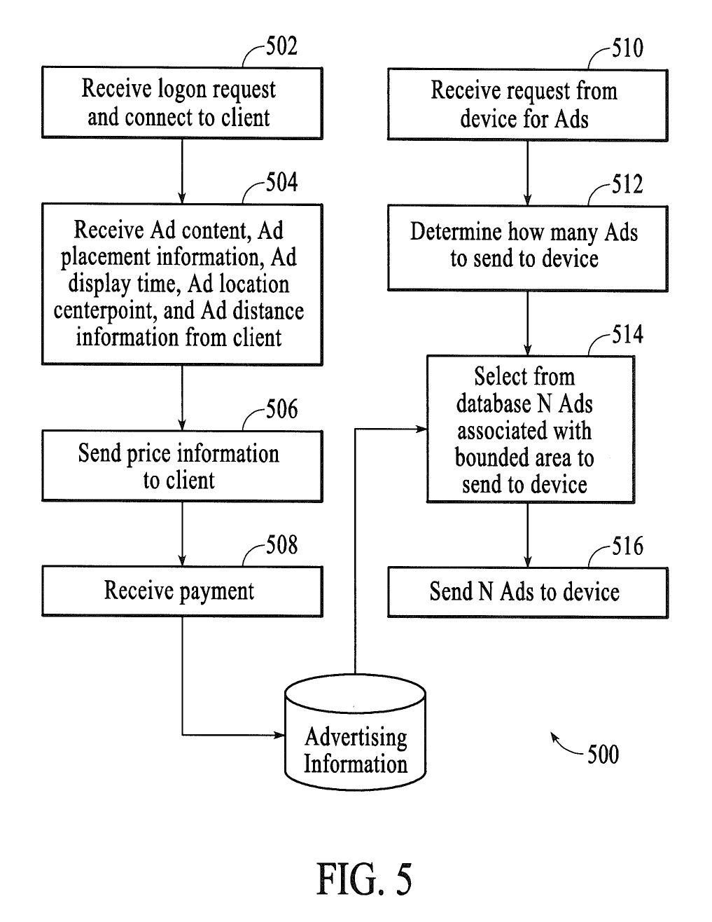

FIGS. 4 and 5 show embodiments of more detailed implementations of the various concepts discussed above. FIG. 4 shows an embodiment of a method 400 of interacting with an advertising server, from the standpoint of an advertising publisher, e.g., a publisher operating publisher computer 204. Method 400 first comprises, at block 402, sending a logon request to the advertising server and connecting to the server. This assumes that the party logging onto the advertising server has already set up an account on the advertising server. Further, this step may include the process of setting up an account on the advertising server where the party connecting to the server is a new user.

Next, method 400 comprises, at block 404, sending distance information, advertising content, advertising placement information, ad display time information, and a center point to the advertising server. As described above, the advertising placement information may comprise information related to the placement of item of advertising content to be displayed and/or any other suitable information. Likewise, the display time information may comprise information related to time periods during which the advertising publisher wishes for its advertising content to be distributed to devices in the selected advertising area. In addition, the center point and distance information will be used to determine the advertising area, such as shown in FIG. 3. It will be understood that such information may be sent to the server at the same time.

After sending information described above, method 400 next comprises, at block 406, receiving pricing information from the advertising server and displaying the pricing information on a user interface. The pricing information may indicate, for example, a price the advertising publisher will be charged for one or more advertising transactions involving the submitted item or items of advertising content. Examples of advertising transactions for which pricing information may be displayed include, but are not limited to, price per advertising area, and so on. The pricing information may be displayed as a single price that is determined based upon the designated advertising area, the placement of the ads, and the desired time interval.

Payment for advertising transactions may be made by the publisher to the ad server administrator in any suitable manner. Examples include, but are not limited to, pre-paid credits, debit or credit cards, lines of credit, and so on.

FIG. 5 illustrates a method 500 of operating an advertising server, under an embodiment. Method 500 illustrates various details of method 400 from the advertising server's point of view, where communications with an advertising publisher computing device are shown in a left-hand side of flowchart 500 and communications with a device are shown in a right-hand side of the flowchart 500. Method 500 first comprises, at block 502, receiving a logon request from an advertising publisher computer, and connecting to the client. Next, at block 504, the advertising publisher defines the advertising area in which it is interested in having its advertising content distributed, as well as the placement area and time interval for the ads. Method 500 next comprises, at block 504, receiving distance information, advertising content, advertising placement information, ad display time information, and a center point from the publisher. Upon receipt of the distance information, advertising content, advertising placement information, ad display time information, and a center point, method 500 comprises, at block 506, sending price information to the publisher. The advertising server may interact with requesting devices on a continuous, rolling basis to provide items of advertising content to the devices. An example of a transaction with a device such as a PND, smartphone, or the like is shown in FIG. 5 at blocks 510-516. First, at bock 510, method 500 comprises receiving from a device a request for advertising content. Upon receipt of this request, it is determined, at block 512, a number N of items of advertising content to send to the device. The number N of items of advertising content may vary depending upon a number of factors, including but not limited to, a type/brand/model of device that sent the request, a current level of zoom currently shown on the device display, and/or whether any advertising publishers have paid for exclusive advertising rights to a particular advertising area.

After determining the number N advertising content items to send to the device, items of advertising content associated with the advertising area are selected from the information database at block 514, and then sent to the device at block 516 for presentation to a user of the device. Further, payment is received, at block 508, from the advertising publishers.

Information about an advertising transaction or transactions that occur after sending the N advertising content items may be stored in the information database (or in any other suitable location). This may be used in preparing status reports to be sent to the advertising publisher. As described above, such status reports may be sent in response to any suitable trigger (e.g., passage of a time interval, occurrence of an advertising transaction, receipt of a request for a report from a client, etc.), and may contain any suitable information. Such status reports may comprise notifications, statistics, and/or cost summaries (for example, regarding total fees paid for occurrences of advertising transactions. It will be understood that these types of information that may be included in status reports are described for the purpose of example, and are not intended to be limiting in any manner.

### Web Portal Implementation

In an web-based implementation, in which network 110 of FIG. 1A represents the Internet, and each of the devices in FIGS. 1A and 2 implement web-based processes, the ad server 104 serves as a portal platform that provides local web content management and publishing system that manages content based on geographical locations. The portal content, such as news, events, photos, business listings, deals and advertising, is stored in a relational database in a data store 120 or 122 that also contains geographical information for any kind of data. For purposes of discussion below, the term ‘business listing’ may be used to represent any appropriate type of promotion or message to be delivered to a user, such as an ad message.

The portal client management processes the output for the particular visitors, based on their current location and the selected search radius specified by the publisher. The visible content will be displayed as it relates to the user's location. This includes local business listings and advertising messages. In an embodiment, the fundamental location information is based on country, region/state and city. The location information that is stored with the content may be represented by an identifier (ID) of the city. The city ID is unique in the location store. It is a pointer to the city itself and has a direct relationship to the related region/state and the country. The region/state is directory related to the country as well. A city object has also a 1:n relationship to a list of city areas and neighborhoods. City areas are represented by their zip code and geographical location (latitude/longitude). The hierarchy of location elements may be as follows:

Country→Region/State City→City Area (ZIP)

A specific example of a location using this hierarchy may be:

USA→California→Palo Alto→94301

Neighborhood information is based on named blocks within a city. These blocks are defined by a list of geographical coordinates that define the enclosed polygon that of the related neighborhood. Named neighborhood information may not always be available, but is typically available for bigger cities. In this case, the hierarchy of location elements may be as follows:

Country→Region/State→City Neighborhood

A specific example of a location using this hierarchy may be:

USA→California→Palo Alto→Crescent Park

The most accurate location information is given by a street address, which is available for some kind of content. A street address is always related to a definite geographical point that is given by its latitude/longitude coordinates. In this case, the hierarchy of location elements may be as follows:

Country→Region/State→City→Street Address

A specific example of a location using this hierarchy may be:

USA→California→Palo Alto→2000 Alma Street

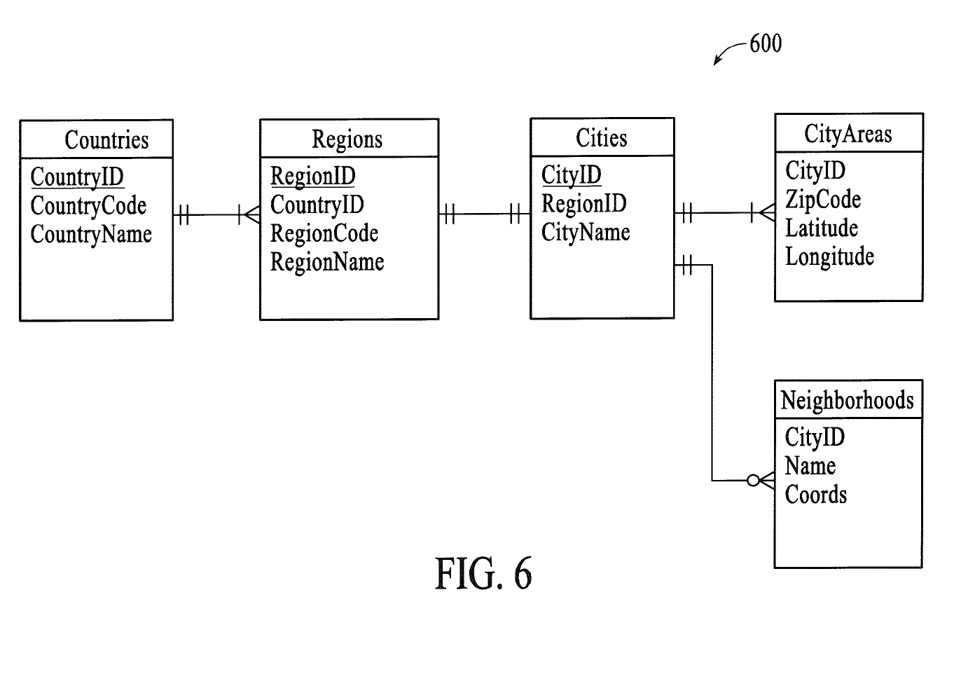

FIG. 6 is a diagram that illustrates the hierarchical schema 600 for representing location using city areas and neighborhoods, under an embodiment.

Location information that is used for local searches usually covers a whole search area that is based on a definite geographical point (latitude/longitude) and a radius (miles/km). A user can extend his active search area by increasing the search radius. A bigger search area will result in more content that is considered as “local content”.

The location assignment to content is explicit, but not always identical for different content types. Content that is related to a street address, such as an event or a business listing, is clearly defined by its definite geographical point. Other content is related to a whole city/neighborhood, a county, region/state or even the entire country. In all cases, the content location is fixed and does not change. Local advertising covers a certain area that is given by the geographical location of its center point and a radius that defines the reach of the ad.

The location of a site visitor (user) is usually fixed, but it can be changed any time by the user. The selection of a different city or neighborhood changes the site content completely. A bigger search radius extends the active search area and results in more results.

With respect to geographical selections, all geographical selections are based on the calculation of the distance from the center point of the search location to the geographical points of the particular search objects. In an embodiment, the calculation of the distance (D) between the two single geographical coordinates (lat1/lon1) and (lat2/lon2) is based on the following formula:

D=R*acos(sin(lat1)*sin(lat2)+cos(lat1)*cos(lat2)*cos(lon2−lon1))

In the above express, R is the radius of the earth (3963 miles=6378 km).

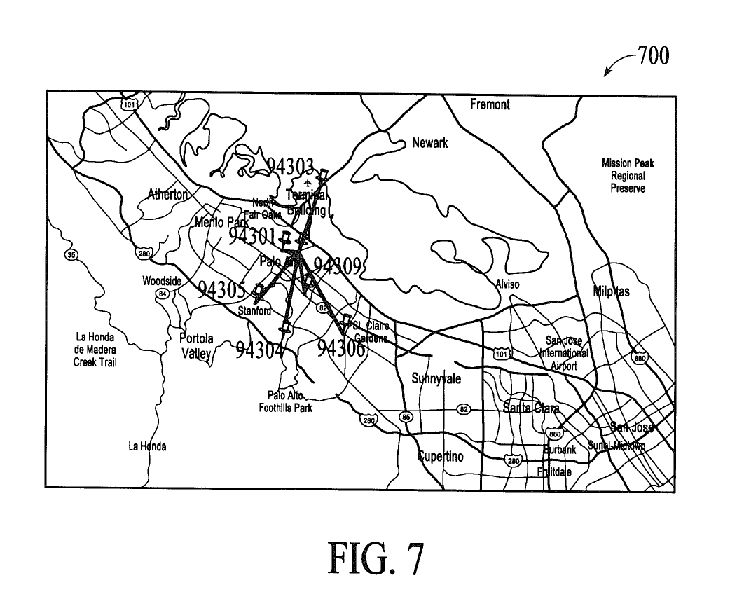

The city ID of a content object provides definite information about the related location. A geographical search will always use the center point of the city if no neighborhood is selected. This is the average value of all latitude/longitude pairs of all city areas that belong to the city. FIG. 7 illustrates the determination of the center point of a city (in this case, Palo Alto, Calif.) based on the average values of lat/long pairs of the city. As shown in map display 700 if FIG. 7, the center point 702 of Palo Alto is based on the distances 704 to the outlying border points of the city.

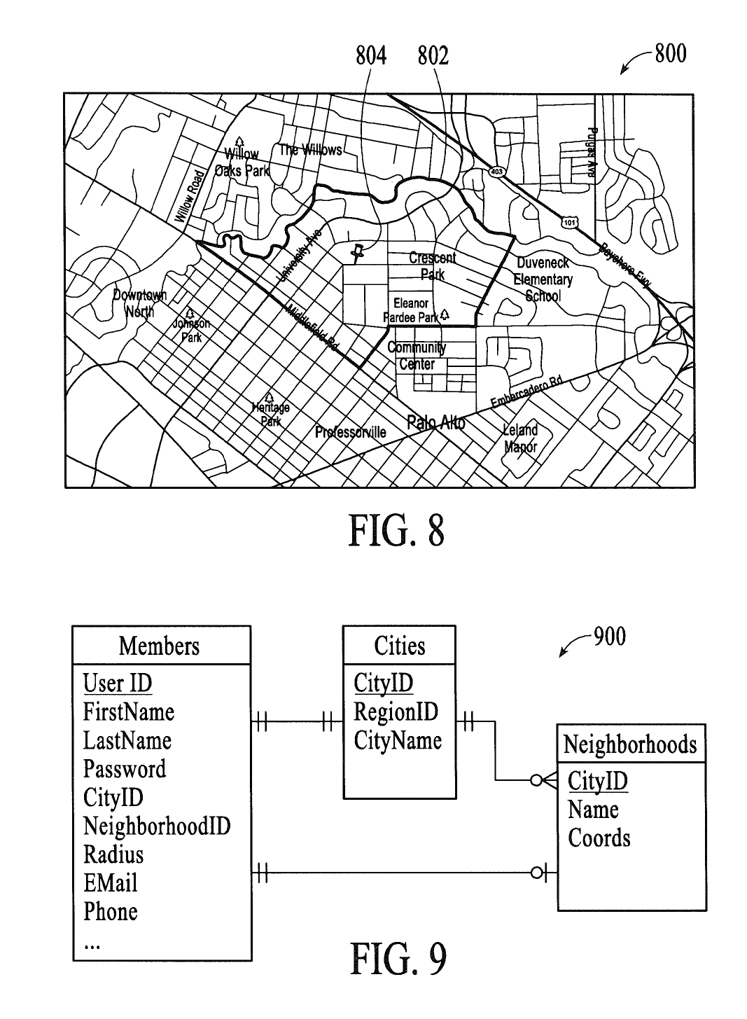

A valid neighborhood ID in addition to the city ID will move the center point of the search area to the center of the neighborhood. The neighborhood center point is calculated by all latitude/longitude pairs given by the polygon that defines the boundary of the neighborhood. FIG. 8 illustrates the determination of a neighborhood of a city, under an embodiment. A shown in FIG. 8, a particular neighborhood (i.e., Crescent Park in Palo Alto) is shown as a polygon 804 centered around center point 802.

One convenient method of specifying urban locations is through the standard postal zip code. However, a zip code by itself does not necessarily define a geographical point, nor does it always belong to one city only. The same zip code can be used for different geographical locations in multiple cities. A zip code however, is important for all kinds of data that contains street address information, such as business records, events or classifieds ads. The final latitude/longitude information is based on the full street address in this case.

Besides the location of a user of a PND or similar client device, the other aspect of location is the location of the content (ad publisher, vendor, service provider, and so on). With regard to content location, the location of the content depends on the content type. Business listings are generally always related to a street address, which is a definite geographical point that is represented by a fixed latitude/longitude pair. The location of a business is generally the most accurate compared to other content types. Any kind of local content is therefore considered as the passive part on the ad server portal. It is considered fixed and does not change. Content will be found by the users, based on their location settings and search radius. In most cases, the content itself does not use any parameters that affect the user's location settings. Location-based advertising, however, is as exception to this rule. The reach of local ads is defined by a radius that drives that ad to the location of its targeted audience, as described with respect to active local advertising. This is illustrated in FIG. 3, where the geographical reach of an ad is defined by the radius of the defined area 302.

In one embodiment, the location of a user is given by a city and neighborhood, as well as a radius that defines the active search area, as shown in FIG. 3. A user can change his location anytime by selecting another city (including country and state/region), zip code or another neighborhood within his current city area. The user can also change the radius, which is given in miles or km depending on the related region. A user's location is represented by the latitude/longitude coordinates of the center point of the selected area and by the current radius. The search radius turns a user into an active instance on the portal site, and search results always depend on the user's location settings. A change of the location will cause a new content selection, which will adjust the actual content according to the new selected location.

Within the ad server process 112, each user is identified by certain data elements, including name, contact information, account password, and location information, such as radius, neighborhood ID, city ID, and so on. The location information determines the search radius and center point location that determines which content will be delivered to the user. FIG. 9 is a diagram that illustrates the hierarchical schema 900 for representing user information including location information, under an embodiment. As shown in FIG. 9, members are specified by certain items of user ID information, and the cities are identified by region ID and city name, while the neighborhoods are identified by the city ID in which they are located, the name and coordinates of the neighborhood.

Using the web portal environment in conjunction with the ad server process, advertising messages can be delivered in two general ways, passive local advertising and active local advertising.

In a passive local advertising embodiment, the promotion of local businesses and/or the offer of goods and services takes place at the location of the business itself. This location is given by the geographical coordinates pointing to the street address of the business. The business location is a fixed point that does not have a radius. With regard to ad visibility, a business listing is visible to all users that have selected a search radius that is big enough to enclose the geographical location of the business. The visibility of a business listing depends on the actual location and search radius of the users only. This kind of advertising is passive, since the audience of users must find the advertised object. In this implementation, the ad server process provides only business listings or relevant ad messages in the users' area of interest.

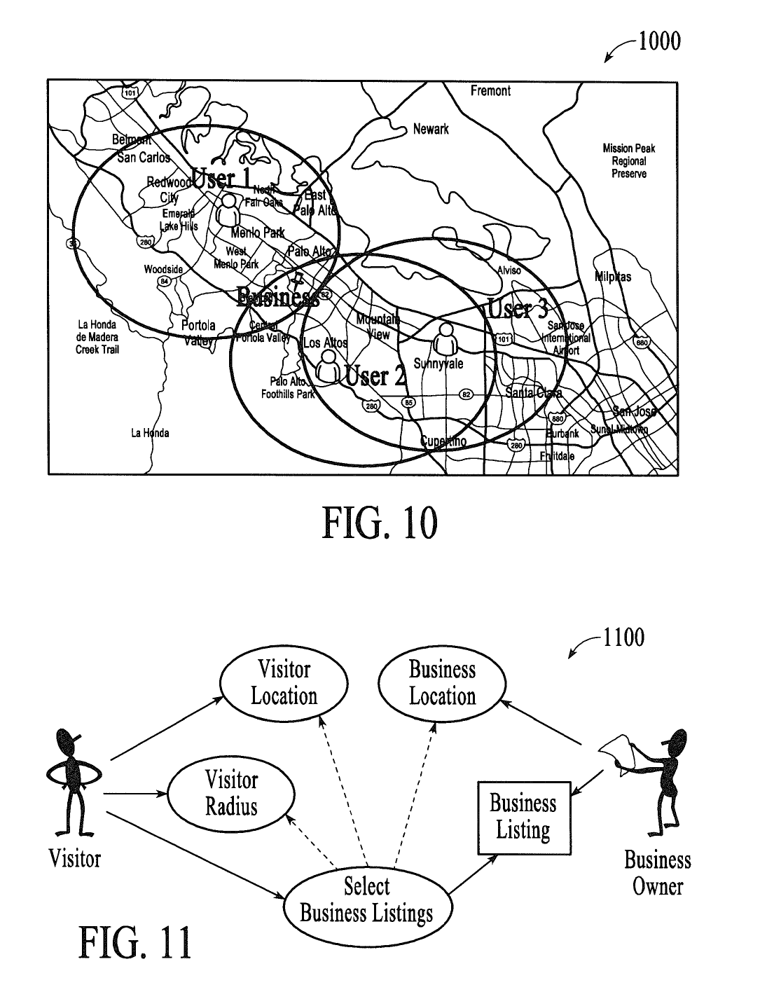

FIG. 10 illustrates an example of different search radii for passive local advertising, under an embodiment. In the example of FIG. 10 on map 1000, the business 1002 is only visible to User 1 and User 2. User 3 will not see the business listings, since his selected radius is not big enough to enclose the location of the business.

In an embodiment, the probability of a promoted business listing being displayed is calculated as follows:

$$P ( \% ) = \frac{Number of listings in the batch * 100 \%}{Total number of business targeted in the {user}^{′} s area}$$

With regard to ad selection, the site user (visitor) plays the active role in the selection process. The actual location and radius of the user are the relevant factors to determine all business listings enclosed within the user's range. FIG. 11 is a use-case diagram that illustrates the fundamental workflow associated with determining the business listings displayed to users in a passive local advertising embodiment. As shown in diagram 1100, the visitor (user) specifies his location and radius, and the business specifies his location and provides the business listing. The ad server process processes these data items to determine the selected business listings that are then provided to the visitor.

In an embodiment, the selection of the relevant business listings for the local business directory (BizDir) is based on the user's location (LAT/LON) and radius (RADIUS) using the following SQL query:

SELECT BizDir.*
FROM BizDir
WHERE fCalcDistance(LAT, LON, BizDir.Lat, BizDir.Long)<=RADIUS

In the above expression, and those that follow below, fCalcDistance is a database function that performs a distance calculation between two points. Any appropriate distance calculation familiar to those of ordinary skill in the art may be used.

In one embodiment, the pricing model for promoted business listings is not based on performance, since the promoted objects are passive and don't have any capabilities that drives the ad into the user's reach. Business listings are usually based on a monthly subscription fee that covers the listing itself, without any additional options to target a certain audience. The price for passive advertising is just a fee for the business listing itself. The business owner is paying to get listed when a visitor targets the business location. The visibility depends only on the visitors.

As stated above, the ad server process and the web portal may also be used to implement active local advertising. This is a performance-driven local advertising method that is a way to target ads based on a geographical location and a radius. The geographical location is given by an advertiser's latitude/longitude coordinates and a radius in miles that defines the reach of the ad. In this embodiment, the ad message is considered as an active instance, since the ad itself defines the targeted area. An ad is visible to all users located within the target location and radius, independent from the users actual search radius. The visibility of a geographical targeted ad depends on the location and the reach of the ad only.

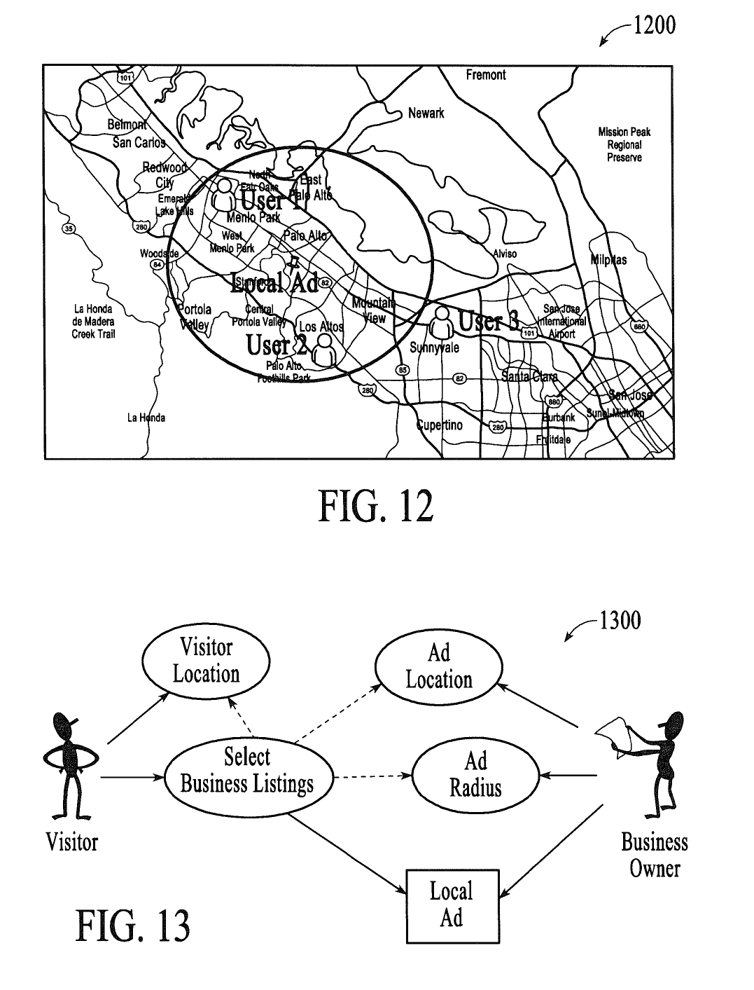

FIG. 12 illustrates an example of a search radius for active local advertising, under an embodiment. In the example of FIG. 12 on map 1200, the radius 1204 of the local ad 1202 encloses the location of User 1 and User 2. This radius 1204 of the ad is not large enough to reach User 3, so user 3 will not see this ad as delivered to Users 1 and 2. This kind of advertising is active, since the advertised object defines the parameters to find its target audience.

In an embodiment of the active local case, the probability of a local ads being displayed is calculated as follows:

$$P ( \% ) = \frac{Number of ads in the batch * 100 \%}{Total number of ads targeted to the {user}^{′} s area}$$

The ad selection is similar to the selection of business listings. The difference is that the location and radius of the ads are relevant to determine the right ads from the ad inventory. FIG. 13 is a use-case diagram that illustrates the fundamental workflow associated with determining the business listings displayed to users in an active local advertising embodiment. As shown in diagram 1300, the visitor (user) specifies his location only, and the business provides an ad message that includes the ad location and ad radius. The ad server process processes these data items to determine the local ads that are delivered to the user based on the selected business listings.

In an embodiment, the selection of relevant ads from the local ad inventory (ads) is based on the user's location (LAT/LON) using the following SQL query:

SELECT Ads.*
FROM Ads
WHERE fCalcDistance(LAT, LON, Ads.Lat, Ads.Long)<=Ads.RADIUS

### Pricing Models

In an embodiment, the pricing model for local advertising is based on the reach of an ad. The reach is defined as a radius in miles or km that is used to calculate the enclosed area from a given geographical point. The total price of an ad is calculated by a unit value multiplied by the number of units, where a unit could be defined in miles or km. The ad performance is controlled by the advertiser itself based on a geographical location and a radius that defines the reach of the ad. In general, the total ad price is based on a price per unit (e.g., $ per mile and day) multiplied by the number of distance units (e.g., miles) and time units (e.g., days). The unit price can be determined by a fixed unit price model, a graduated unit price model, and a pricing based on bidding.

Under the fixed unit price model, the unit price is defined by the ad publisher. The unit price can be set to a value that is different for various locations and ad placements, but it is independent from the reach and run time of an ad. The unit price represents the cost per distance unit and run time of the ad. Under the fixed price model, the total price of an ad is calculated as follows:

$$Ad price = \frac{Price}{Distance * Time} * Num . distance units * Num . time units$$

For example, if the unit price is $1.50 per mile per day, the total ad price for a showing the ad for ten days within five miles of a location is:

Ad price=($1.50/mile*day)*5 miles*10 days=$75.00

Under the fixed pricing model, unit price of all ads are fixed based on the per distance and time factor, and the visibility of the ad depends on the targeted geographical location and the radius only. The ad will be visible to all users within the enclosed area, independent from a user's search radius. The fixed pricing model does not process ads based on weight or ranking algorithms, since all ads are based on the same unit price.

In the fixed price method, ad delivery is relatively simple since the goal is to distribute all ads in the local ad repository evenly. This can be accomplished by counting the number of impressions or the display time. For the impression-based case, the ads are selected based on the average number of impressions per day. Ads with fewer impressions are selected first to keep the number of impressions even. A query can be used to select a batch of a number (e.g., 10) of relevant ads from the local ad inventory (Ads) based on the user's location (LAT/LON) and the average number of ad impressions per day (Ads. ImpressionsPerDay). Following is an example of such a SQL query:

SELECT Ads.*
FROM Ads
WHERE fCalcDistance(LAT, LON, Ads.Lat, Ads.Long)<=Ads.RADIUS
ORDER BY Ads.ImpressionsPerDay
LIMIT 10

For the case of ad visibility based on display time, the ads are selected based on the average display time per day. Ads with shorter display time are selected first to keep the display times even. A query can be used to select a batch of a number (e.g., 10) of relevant ads from the local ad inventory (Ads) based on the user's location (LAT/LON) and the average display time per day (Ads.TimePerDay). Following is an example of such a SQL query:

SELECT Ads.*
FROM Ads
WHERE fCalcDistance(LAT, LON, Ads.Lat, Ads.Long)<=Ads.RADIUS
ORDER BY Ads.TimePerDay
LIMIT 10

Under the fixed pricing model, the probability of a local ad being displayed is calculated as follows:

$$P ( \% ) = \frac{Number of ads in the batch * 100 \%}{Total number of ads targeted to the {user}^{′} s area}$$

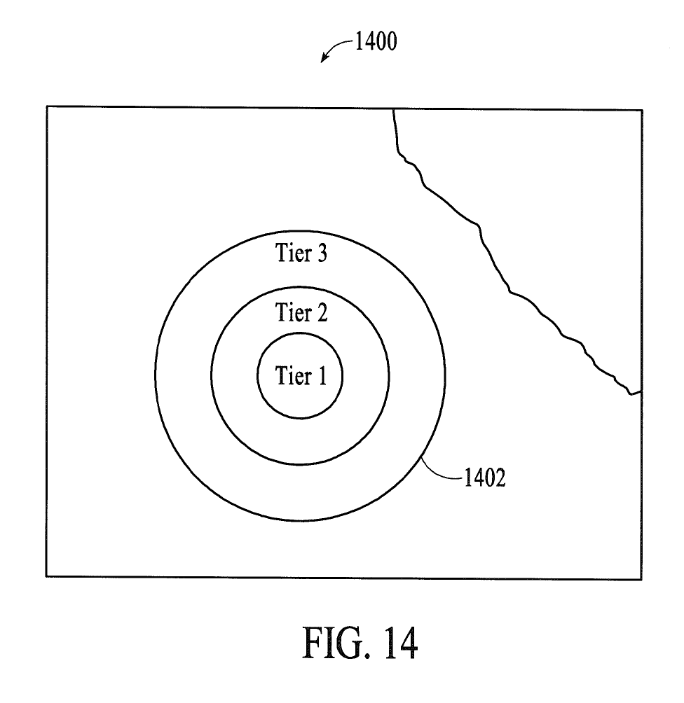

A second pricing model is based on graduated unit prices rather than fixed unit prices. The graduated pricing model implements multiple tiers of fixed pricing or different pricing structures depending on the geographical reach or overall run time of an ad. A graduated pricing model allows different prices for metro, suburban and rural areas especially for ad campaigns with long range. It can also be used to offer special discounts for higher reach ads or ad campaigns with a longer runtime. FIG. 14 illustrates an example of a different pricing tiers based on geographic distance in a graduated pricing model, under an embodiment. As shown in FIG. 14, map 1400 of a certain geographical region is divided into circular areas 1402 of different radii. As the distance from the center of the geographic region increases, different pricing tiers, denoted tier 1, tier 2, and tier 3 are assigned. In general, the ad price decreases as the distance increases, reflecting a greater value the closer one is to the center of the ad region.

The graduated pricing model assigns different unit prices to different ranges and/or runtimes. The tables (Table 1 and Table 2) below illustrate examples of a graduated pricing model based on both range and duration (runtime).

TABLE 1
Distance-based graduation

| Range | Price per mile/day |
|---|---|
| 0-3 miles | $2.00 |
| 3-10 miles | $1.50 |
| over 10 miles | $0.50 |

TABLE 2
Time-based graduation

| Duration | Price per mile/day |
|---|---|
| 0-3 days | $2.00 |
| 4-10 days | $1.50 |
| Over 10 days | $0.50 |

In an embodiment, the ad price under the graduated pricing model for a distance-based graduation is calculated using the following equation:

$$Ad price ( 1 , n ) \sum \frac{Price ( n ) * Num . distance units ( n )}{Distance * Time} * Number of time units$$

For example, if the price is $2.00 per mile per day for two miles and $1.50 per mile per day for three miles, the total ad price for a ten-day campaign is:

Ad price=(($2.00/mile*day)*2 miles+($1.5/mile*day)*2 miles))*10 days=$70.00

Similarly, the ad price under the graduated pricing model for a distance-based graduation is calculated using the following equation:

$$Ad price ( 1 , n ) = \sum \frac{Price ( n ) * Num . time units ( n )}{Distance * Time} * Num . distance units$$

For example, if the price is $2.00 per mile per day for three days and $1.50 per mile per day for seven days, the total ad price for a five-mile radius is:

Ad price=(($2.00/mile*day)*3 days+($1.5/mile*day)*7 days))*5 miles=$82.50

For the graduated price model, the ad visibility is the same as that for the fixed price model. A graduated pricing model generally does not affect the visibility of an ad since the price is still the same for all ads in the inventory. Likewise, the probability of being displayed is identical with the fixed price model, since the weight of all ads is identical.

The third pricing model is pricing based on bidding that allows advertisers to name their price to pay for an ad. In the bid-based pricing model, the price of an ad is based on an average price for a target area and bids received by a plurality of advertisers. The average unit price for a certain geographical area is a result of the biddings in the area. In this manner, the unit price is driven by supply and demand in that area.

In an embodiment of the bidding price model, the total price of an advertising campaign is calculated based on the fixed-price model, with the difference that the unit price is not fixed in this case. Since the unit price becomes another variable factor in addition to radius and run time in this case, the ad is competing with other ads in the inventory. Therefore, the visibility of the particular ads depends primarily on the unit price an advertiser has paid. In this case, every single ad in the inventory has its own weight that is represented by the relation to the average unit price in the targeted area. The relative weight of an ad is calculated as follows:

$$Weight ( \% ) = \frac{Unit price * 100 \%}{Average unit price in the target area}$$

A relative weight of 100% defines the average weight of the ad delivery process. Ads with a higher or lower relative weight will receive a higher or lower visibility that is calculated based on the parameters of the actual batch of ads. The total ad price depends only on parameters given by the advertiser itself. The performance of the ad campaign is calculated based on the visibility of the ad. The ad ranking within the local inventory can be calculated based on the total number of ads in the targeted geographical area and their relative weight. This value can be used as a performance preview that supports the advertiser during the bidding process.

The ad visibility in the bid-based system is based on the relative weight of the ad in addition to the regular geographical parameters and its number of impressions or display time. The relative weight value is converted in to a multiplier that represents a reciprocal value of the ad weight. This multiplier is a kind of score factor that is used to revalue that actual impressions or display time during the selection process of the delivery batch:

$$Score = \frac{Relative weight ( \% )}{100 \%}$$

In the case of selection based on impressions, the ads are selected based on the average number of impressions per day. Ads with fewer impressions are selected first to keep the number of impressions even. The score factor is used as a multiplier to revalue the number of impressions.

A query can be used to select a batch of a number (e.g., 10) of relevant ads from the local ad inventory (Ads) based on the user's location (LAT/LON) and the average number of ad impressions per day (Ads.ImpressionsPerDay) and the score factor (Ads.Score). Following is an example of such a SQL query:

SELECT Ads.*
FROM Ads
WHERE fCalcDistance(LAT, LON, Ads.Lat, Ads.Long)<=Ads.RADIUS
ORDER BY Ads.ImpressionsPerDay * Ads.Score
LIMIT 10

Since the score value is reciprocal to the relative weight of an ad and the query returns the ads with the lowest number of impressions first, the score factor will affect the ads with a height relative weight in a positive way.

In the case of selection based on display time, the ads are selected based on the average display time per day. Ads with shorter display time are selected first to keep the display time even. The score factor is used as a multiplier to revalue the display time.

A query can be used to select a batch of a number (e.g., 10) of relevant ads from the local ad inventory (Ads) based on the user's location (LAT/LON), the average display time per day (Ads.TimePerDay) and the score factor (Ads.Score):

SELECT Ads.*
FROM Ads
WHERE fCalcDistance(LAT, LON, Ads.Lat, Ads.Long)<=Ads.RADIUS
ORDER BY Ads.TimePerDay * Ads.Score
LIMIT 10

Since the score value is reciprocal to the relative weight of an ad and the query returns the ads with the shortest display time first, the score factor will affect the ads with a height relative weight in a positive way.

The probability of an ad being displayed depends on the relative weight of the ads in addition to batch size and the size of the whole local inventory. This will extend the fundamental calculation as follows:

$$P ( \% ) = \frac{Relative weight * Number of ads in the batch * 100 \%}{Total number of ads in the target area * 100 \%}$$

This probability expression can be simplified as follows:

$$P ( \% ) = \frac{Relative weight * Number of ads in the batch}{Total number of ads in the target area}$$

Embodiments are directed to a computer-implemented method of delivering ad messages from an advertiser to one or more users operating client devices, comprising: receiving from the advertiser an item of advertising content associated with a bounded distance from a physical geographic location; receiving from each client device, location information for each respective client device and a request for advertising content associated with the bounded distance; determining which of the client devices are within the bounded distance based on the device location information for each client device; transmitting the item of advertising content associated with the request to each client device that is within the bounded distance for display to the respective user; and determining a price to be paid for the transmission of the advertising content to the respective user, wherein the price is based on the distance from the physical geographic location. In an embodiment of the method, the geographic location and the bounded distance are defined by a location associated with the advertiser, and wherein the geographic location is either fixed or dynamic. The bounded distance may be defined at least in part by a search radius specified by each user of a client device, wherein the search radius dictates an area for which the corresponding user desires to receive available advertising content. The method may further comprise receiving geographic location information from the advertiser to determine the center point of a bounded advertising area, and wherein the bounded distance comprises a plurality of bounded distances defining a plurality of tiered pricing regions, each tiered pricing region specifying at least one of: a different charge per ad based on distance of the tiered pricing region from the center point, and a runtime of the ad, and a different charge per ad based on the runtime of the ad within a single tiered pricing region.

In an embodiment of the method, the step of determining a price to be paid for the transmission of the advertising content to the respective user, comprises determining an initial fixed unit price per ad by assigning a unit price to the ad based on a per distance and per runtime duration multiplied by a number of distance units for the reach of the ad and a number of time units for the duration of the ad; assigning a relative weight to the ad that represents the unit price of the ad to the average unit price for a targeted area; and assigning a final price based on a number of bids received by different advertisers.

In an embodiment, the client device is a location-aware mobile device comprising one of: a personal navigation device, a personal computer, a portable computing device, a smart phone, and a personal digital assistant. The method may further comprise receiving advertising placement information from the advertiser configured to adapt the advertising message for display on the client device. The client device location information may be provided by the client device in the form of latitude/longitude data, and wherein the geographic location information is provided in the form of address information. The geographic location information may be derived from a location hierarchy utilizing city identifier information. The advertising content may be selected from the group comprising: a text message, a graphic advertising message, a video advertising message, an audio advertising message, a business listing, a promotional offer, and a redeemable electronic coupon.

Embodiments have been described herein for a method and system of delivering ad messages from an advertiser to one or more users operating client devices, comprising: receiving from the publisher an item of advertising content associated with a bounded distance from a physical geographic location; receiving from each client device location information for each respective client device and a request for advertising content associated with the bounded distance; determining which of the client devices are within the bounded distance based on the device location information for each client device; and transmitting the item of advertising content associated with the request to each client device that is within the bounded distance for display to the respective user.

It will be understood that the term “computing device” and any component, circuit or module for performing a “computer-implemented method” as used herein may refer to any suitable type of computing device configured to execute programs. Such computing device may include, but are not limited to, a mainframe computer, personal computer, laptop computer, portable data assistant (PDA), computer-enabled wireless telephone, networked computing device, combinations of two or more thereof, etc. Likewise, the term “requesting/receiving device” and the like (e.g. where the abbreviated term “device” is used to refer to such a device) also may refer to any suitable type of computing device that can access a network and receive advertising content. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that a computer-readable storage medium may be provided having program instructions stored thereon, which upon execution by a computing device, cause the computing device to execute the methods described above and cause operation of the systems described above.

Aspects of the system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the location-based ad delivery system is not intended to be exhaustive or to limit the embodiments to the precise form or instructions disclosed. While specific embodiments of, and examples for, the disclosed method and system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

What is claimed is:

1. A computer-implemented method of delivering ad messages from an advertiser to one or more users operating client devices, comprising:
receiving from the advertiser an item of advertising content associated with a bounded distance from a physical geographic location;
receiving from each client device, location information for each respective client device and a request for advertising content associated with the bounded distance;
determining which of the client devices are within the bounded distance based on the device location information for each client device;
transmitting the item of advertising content associated with the request to each client device that is within the bounded distance for display to the respective user; and
determining a price to be paid for the transmission of the advertising content to the respective user, wherein the price is based on the distance from the physical geographic location.

2. The method of claim 1, wherein the geographic location and the bounded distance are defined by a location associated with the advertiser, and wherein the geographic location is fixed.

3. The method of claim 1, wherein the geographic location and the bounded distance are defined data associated with the advertising content, and wherein the geographic location is dynamic.

4. The method of claim 1, wherein the bounded distance is defined at least in part by a search radius specified by each user of a client device, wherein the search radius dictates an area for which the corresponding user desires to receive available advertising content.

5. The method of claim 1, further comprising receiving geographic location information from the advertiser to determine the center point of a bounded advertising area, and wherein the bounded distance comprises a plurality of bounded distances defining a plurality of tiered pricing regions, each tiered pricing region specifying at least one of: a different charge per ad based on distance of the tiered pricing region from the center point, and a runtime of the ad, and a different charge per ad based on the runtime of the ad within a single tiered pricing region.

6. The method of claim 1, wherein the step of determining a price to be paid for the transmission of the advertising content to the respective user, comprises:
determining an initial fixed unit price per ad by assigning a unit price to the ad based on a per distance and per runtime duration multiplied by a number of distance units for the reach of the ad and a number of time units for the duration of the ad;
assigning a relative weight to the ad that represents the unit price of the ad to the average unit price for a targeted area; and
assigning a final price based on a number of bids received by different advertisers.

7. The method of claim 1 wherein the client device is a location-aware mobile device comprising one of: a personal navigation device, a personal computer, a portable computing device, a smart phone, and a personal digital assistant.

8. The method of claim 7, further comprising receiving advertising placement information from the advertiser configured to adapt the advertising message for display on the client device.

9. The method of claim 7 wherein the client device location information is provided by the client device in the form of latitude/longitude data, and wherein the geographic location information is provided in the form of address information.

10. The method of claim 9 wherein the geographic location information is derived from a location hierarchy utilizing city identifier information.

11. The method of claim 10, wherein the step of determining a price to be paid for the transmission of the advertising content to the respective user based on one of a fixed pricing model that imposes the same price on all ads for a certain geographic reach and runtime duration, a graduated pricing model that imposes a different price on ads depending on at least one of geographic reach and runtime duration, and a bidding model that imposes a price based on an average price for a target area and bids received by a plurality of advertisers.

12. The method of claim 11 wherein the advertising content is selected from the group comprising: a text message, a graphic advertising message, a video advertising message, an audio advertising message, a business listing, a promotional offer, and a redeemable electronic coupon.

13. A computing device, comprising:
a processor; and
memory coupled to the processor, the memory comprising instructions stored thereon that are executable by the processor to perform a method of distributing advertising content from an advertiser to a user of a client device, the method comprising: receiving from the advertiser an item of advertising content associated with a bounded distance from a physical geographic location; receiving from each client device, location information for each respective client device and a request for advertising content associated with the bounded distance; determining which of the client devices are within the bounded distance based on the device location information for each client device; transmitting the item of advertising content associated with the request to each client device that is within the bounded distance for display to the respective user; and determining a price to be paid for the transmission of the advertising content to the respective user, wherein the price is based on the distance from the physical geographic location.

14. The computing device of claim 13, wherein the instructions are further executable to determine a price to be paid for the transmission of the advertising content to the respective user based on one of a fixed pricing model that imposes the same price on all ads for a certain geographic reach and runtime duration, a graduated pricing model that imposes a different price on ads depending on at least one of geographic reach and runtime duration, and a bidding model that imposes a price based on an average price for a target area and bids received by a plurality of advertisers.

15. The computing device of claim 13, wherein the geographic location and the bounded distance are defined by one of: a location associated with the publisher, and wherein the geographic location is fixed, and defined data associated with the advertising content, and wherein the geographic location is dynamic.

16. A computer-readable storage medium containing program instructions executable by a computing device to perform a method of distributing advertising content, the method comprising:
receiving from an advertiser an item of advertising content associated with a bounded distance from a physical geographic location;
receiving from each client device, location information for each respective client device and a request for advertising content associated with the bounded distance;
determining which of the client devices are within the bounded distance based on the device location information for each client device;
transmitting the item of advertising content associated with the request to each client device that is within the bounded distance for display to the respective user; and
determining a price to be paid for the transmission of the advertising content to the respective user, wherein the price is based on the distance from the physical geographic location.

17. The computer readable storage medium of claim 17, wherein the instructions are further executable to determine a price to be paid for the transmission of the advertising content to the respective user, wherein the price is based on the distance from the physical geographic location.

18. The computer-readable storage medium of claim 17, wherein the geographic location and the bounded distance are defined by one of: a location associated with the publisher, and wherein the geographic location is fixed, and defined data associated with the advertising content, and wherein the geographic location is dynamic.
